(19) United States
(12) Patent Application Publication
(10) Pub. No.: US 2008/0314697 A1
(43) Pub. Date: Dec. 25, 2008

(54) Disk Brake

(75) Inventor: Eugen Kloos, Bensheim (DE)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: WABCO Radbremsen GmbH, Mannheim (DE)

(21) Appl. No.: 11/914,936

(22) PCT Filed: May 18, 2006
(86) PCT No.: PCT/EP2006/004737

§ 371 Date: Dec. 13, 2007

(30) Foreign Application Priority Data
May 19, 2005 (DE) 10 2005 023 116.0

(51) Int. Cl. F16D 65/00

(52) U.S. Cl. 188/73.1; 188/73.39

(57) ABSTRACT

The invention relates to a disk brake having a brake dirk (22) with a rotational axis (A) and a preferred running direction (1), having an application device, having a brake caliper (12) with a first caliper limb (32) which is arranged on a first side of the brake disk and with a second caliper limb (30) which is arranged on a second side, situated opposite the first side, of the brake disk and is offset relative to the first caliper limb by a predetermined distance (V) in the direction of the brake disk run-out side, having a first brake lining (14) which, during braking, bears by means of a first rear face against a first contact face on the application device, and by means of a first friction face (20) against the brake disk, and having a second brake lining (16) which, during braking, bears by means of a second rear face (26) against a second contact face (28) on the second caliper limb, and by means of a second friction face (24) against the brake disk, and is supported on the second caliper limb in the peripheral direction of the brake disk by means of a third contact face (36). According to the invention, it is provided that the second rear face, as viewed in the direction of the rotational axis, projects beyond the second contact face in a radically outer region on the disk run-out side.

### CROSS REFERENCE TO RELATED APPLICATIONS

The present application is a national phase entry of, and claims priority under 35 U.S.C. § 120 to, International Patent Application No. PCT/EP2006/004737, filed May 18, 2006, entitled “Scheibenbremsen,” which designates the United States of America and which claims priority to German Patent Application No. 10 2005 023 116.0, filed May 19, 2005, entitled “Die folgenden Angaben sind den vom Anmelder eingereichten Unterlagen entnommen,” the entire contents and disclosures of which are hereby incorporated by reference in their entirety.

### FIELD OF THE INVENTION

The present invention relates to brakes and, more particularly, to disk brakes.

### BACKGROUND

A disk brake of the above-cited type is described in German patent application 10 2004 009 123 submitted on Mar. 1, 2004.

It is known that disk brakes with a sliding caliper have a brake lining on the application side that is pressed against the brake disk during braking by means of the application device, and the brake caliper shifts axially due to the arising reaction force which also causes the reaction-side brake lining to contact the brake disk by means of the caliper limb at that location. During braking, wear from friction arises as a function of the braking intensity and duration of braking. In practice, an effort is made to extend the service life by providing suitable designs and preventative measures to achieve very even lining abrasion and a very even wear pattern on the friction strip or surface of the brake disk.

A “brake lining” is normally understood to mean a backplate with a friction material affixed to it.

Since the linings of commercial vehicle brakes are normally relatively long with a correspondingly large contact surface or friction surface, a correspondingly large contact surface is conventionally provided on the reaction-side caliper limb to allow the lining to evenly press against the brake disk. For this reason, the contact areas of known brakes essentially correspond to the area of the backplate. They are symmetrically formed on the caliper limb and are also symmetrically arranged with reference to the backplate on the caliper limb.

In conventionally designed disk brakes, both brake linings are designed to be highly similar and are arranged on both sides of the brake disk so that they symmetrically oppose each other. They are guided and supported in lateral directions and radially inward in shafts of the backplate encompassing the brake disk. Peripheral braking forces/tangential forces arise during braking when the brake lining contacts the brake disk in direction of rotation of the brake disk, said forces being partially absorbed by the backplate and partially by the reaction surface of the local caliper limb as friction between the backplate and caliper contact surface (friction in a tangential direction).

With this design, the rim-side caliper limb moves radially outward during braking due to the construction and brake kinematics as well as the caliper elasticity. The caliper expands. As a consequence of this relative movement between the caliper limb and the rim-side brake lining, the radial lining contact is uneven with uneven wear.

A disk brake is known in EP 405 778 A1 in which the caliper limb and hence the brake linings are not offset from each other. In addition, the rim-side brake lining is not supported against the rim-side caliper limb but rather against the backplate. The rim-side caliper limb executes a radial outward movement during braking. In contrast, it executes a radial inward movement when the rim-side brake lining is not supported against the backplate but against the rim-side caliper limb.

With the brake in EP 405 778 A1, the brake caliper expands during braking, and partial overloads are compensated by different elasticities/contacts (main claim) of the two fingers of the rim-side caliper limb.

The brake caliper behaves in a completely different manner in disk brakes of the initially cited design in which the application-side brake lining can be guided and supported in a backplate, but the reaction-side/rim-side brake lining is directly supported against the local caliper limb, and the rim-side caliper limb is offset in relation to the application-side caliper limb by a predetermined path in the direction of the brake disk run-out side. With this type of design, substantial peripheral force arises on the brake caliber during braking so that the rim-side caliper limb tries to lower radially inwards and simultaneously move laterally in the direction of rotation of the brake disk.

With the described caliper movements, especially during long or emergency braking, a pressure point shift arises between the caliper limb and the brake lining toward the brake disk run-out side. The lining is thereby not evenly and completely pressed, and overloads arise in the areas of increased pressure. In other words, increased force from the caliper movement/deformation arises in addition to the application force, at least locally.

This is schematically illustrated in FIG. 9. The peripheral force Fu arising during braking presses the brake lining against the local support strip via its backplate. The reaction force Fu′ and friction Fr prevents in the lining from deforming. In conjunction with the pressure point shift, local overheating of the brake lining and brake disk arises which causes heat cracks/hot spots in the brake disk and/or the brake lining which lead to excessive local wear, which in turn reduces the service life.

### SUMMARY

The invention is therefore based on the problem of overcoming the above-cited disadvantages, and especially preventing or at least reducing pressure overloads in the rim-side brake lining and heat crack formation in the brake disk. The present invention provides a disk brake having a brake disk with a rotational axis and a preferred running direction; an application device having a brake caliper with a first caliper limb which is arranged on a first side of the brake disk and with a second caliper limb which is arranged on a second side situated opposite the first side of the brake disk, said second caliper limb being offset relative to the first caliper limb by a predetermined distance in the direction of the brake disk run-out side; having a first in brake lining which, during braking, bears by means of a first rear surface against a first contact surface on the application device, and by means of a first friction surface against the brake disk; and having a second brake lining which, during braking, bears by means of a second rear surface against a second contact surface on the second caliper limb, and by means of a second friction surface against the brake disk, and is supported on the second caliper limb in the peripheral direction of the brake disk by means of a third contact surface.

According to the invention, the posed problem is solved in that the second back surface viewed in the direction of the rotational axis projects beyond the second contact surface in a radially outside area at the brake disk run-out side.

In other words, a free area where the brake lining can escape is created in the critical zone between the second (rim-side) caliper leg and the second (rim-side) brake lining.

No local overload arises (brake lining against brake disk) despite the caliper deformation, even when there is a pressure point shift toward the brake lining. The brake lining can elastically escape into the free area in the critical zone of increased pressure at the disk run-out side. The brake lining is less resistant to bending in the area of the projection because it can escape into the free area.

The invention especially provides that the second back surface viewed in the direction of the rotational axis projects beyond the second contact surface in a radial, outside area on the brake disk run-in side.

The projecting area on the brake disk run-in side is preferably larger than the projecting area on the brake disk run-out side. This creates favorable geometry for the overall behavior. In particular, it is noted that the projecting area on the brake disk run-in side can be next to nothing, or shrink to an irrelevant amount in regard to the mechanics.

This design prevents overloads (increased wear, heat cracks, etc.) even when driving backwards.

In a particularly preferred embodiment of the invention, the second caliper limb in the area of projection of the second back surface beyond the second contact surface is recessed with reference to the second contact surface.

In other words, it is stepped. This embodiment makes it possible to design the first and second brake lining the same so that they cannot be confused.

In addition or alternately, the second brake lining can be recessed with reference to the second back surface in the area where the second back surface projects beyond the second contact surface.

Additionally, the second caliper limb can be at an angle in relation to the second contact surface to form the projection of the second back service beyond the second contact surface.

In other words, the invention also includes a solution in which the above-cited free area is wedge-shaped.

In another particularly preferred embodiment of the invention, an edge of the area where the second back surface projects beyond the second contact surface encloses an angle of 5° to 60°, preferably 15° to 45° and especially preferably 25° to 35° with the third contact surface.

In other words, an approximately triangular free surface is created that neighbors the free area. The dimensions of this contact-free free area are such that the brake lining in this area can escape by the amount of elastic caliper deformation that arises there. This thereby eliminates local overloading.

Even more preferable according to the invention, the second contact surface is rotated with reference to the first contact surface.

In addition or alternately, the second contact surface can also be swung on the rotational axis of the brake disk with reference to the first contact surface. This corresponds to an embodiment in which, despite the offset, both caliper limbs are the same radial distance from the rotational axis of the brake disk.

In a particularly preferred embodiment of the invention, a connecting device is provided to connect the first caliper limb to the second caliper limb that is radially closer to the brake disk on the brake disk run-out side than on the brake disk run-in side, at least in the area in which said connecting device overlaps the brake disk.

This enables the caliber to transfer all the strong application force without expanding, and to rotate in the preferred rotational direction of the disk within the given elasticity range upon braking without colliding with the brake disk or a wheel rim surrounding the brake.

The disk brake according to the invention is preferably a sliding caliper brake or fixed caliper disk brake.

Even more preferably, the disk brake is a two-spindle brake.

Finally, the invention is preferably applicable to a commercial vehicle brake.

In addition to the disk brake, a brake caliper for a disk brake of the above-described in type is also created by the invention.

Finally, a brake lining for a disk brake of the above-cited type also created by the invention.

### BRIEF DESCRIPTION OF THE DRAWINGS

The invention will be further explained in the following with additional details with reference to a preferred exemplary embodiment in the accompanying drawings.

FIG. 1 is a side view of a preferred exemplary embodiment of the brake but without the brake disk;

FIG. 2 is a plan view of the brake from FIG. 1;

FIGS. 3 to 5 are perspective views of the brake caliper of the brake from FIGS. 1 and 2;

FIG. 6 is a view of the rim-side caliper limb of the caliper from FIGS. 3 to 5 as viewed from the brake disk;

FIG. 7 is a view of the rim-side brake lining viewed from the brake disk installed in the rim-side caliper limb from FIG. 6;

FIG. 8 is a combination of FIGS. 6 and 7;

FIG. 9 is a schematic plan view of a conventional disk brake;

FIG. 10 is a schematic plan view of the disk brake from FIGS. 1 and 2; and

FIG. 11 illustrates an alternative design of the brake lining from FIG. 7.

### DETAILED DESCRIPTION

The brake shown in the drawing has a backplate 10 that is firmly affixed to a vehicle and that bears a sliding caliper 12. In addition, the displayed brake has an actuation-side brake lining 14 as well as a rim-side brake lining 16. The two brake linings 14, 16 are held in position by a clip 18. The brake lining 14 has a friction surface 20 to contact a brake disk 22. The brake lining 16 has a friction surface 24 to contact brake disk 22. The rim-side brake disk 16 has a back surface 26 opposite the friction surface 24 by means of which it contacts a contact surface 28 of a rim-side limb 30 of the caliper 12. An actuation-side caliper limb is provided with reference number 32. The brake lining 14 has a back surface (not shown) opposite friction surface 20. The back surface contacts a corresponding surface of an application or actuation device (not shown).

The rim-side caliper limb 30 is offset/rotated by length V with reference to the actuation-side caliper limb 32 toward a disk run-out side.

As can be seen in FIGS. 7 and 8, the rim-side brake lining 16 is supported via two contact surfaces 34, 36 in the peripheral direction against shoulders 38, 40 of the rim-side caliper limb 30.

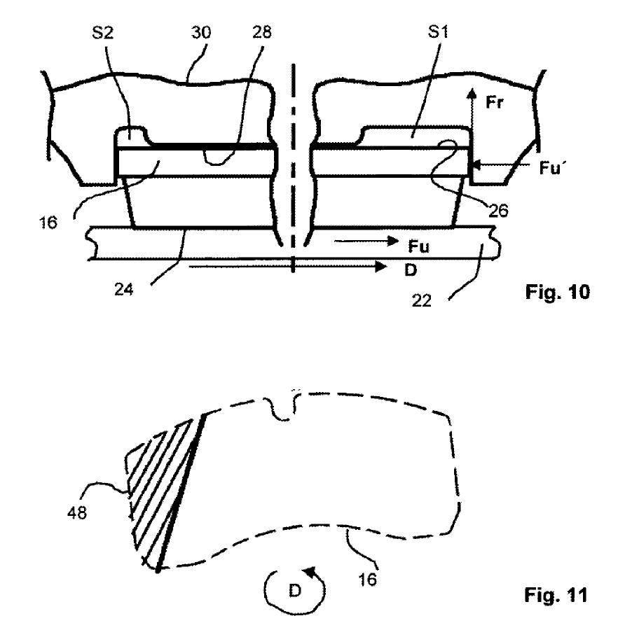

As can be seen in FIG. 8 and FIG. 10, in particular, the contour of contact surface 28 does not match the contour of back surface 26. Instead, the back surface 29 projects beyond the contour of the contact surface 28. Free areas S1 and S2 arise into which the rim-side brake lining 16 can escape. Free area S1 is essentially triangular because the part of its edge assigned reference number 42 in FIG. 8 encloses a sharp angle α with contact surface 36. In the exemplary embodiment in the drawing, angle α=28°.

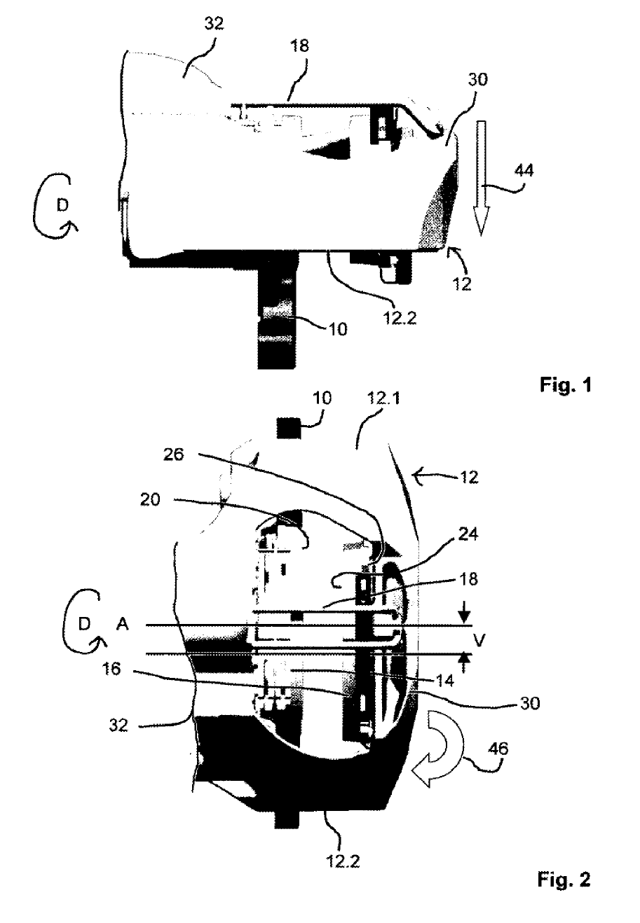

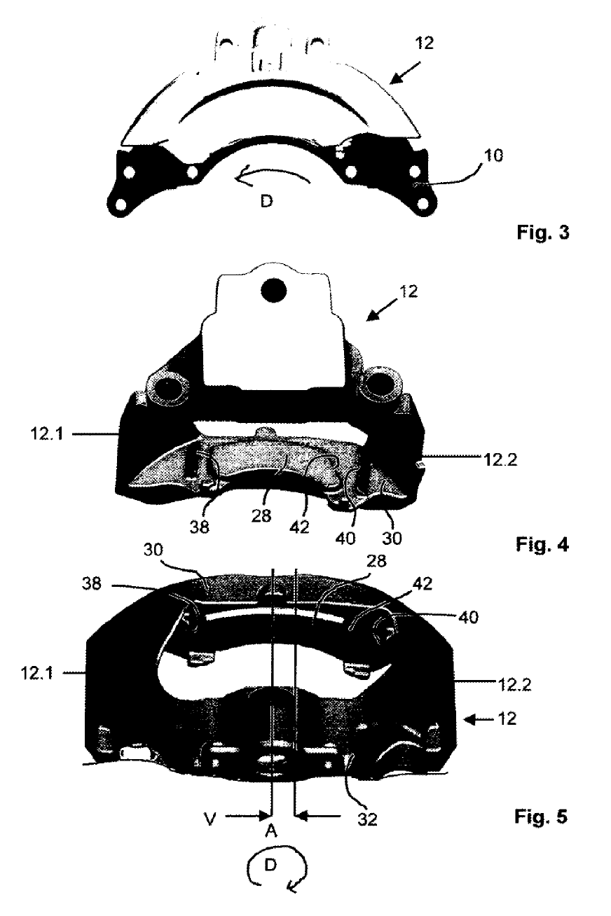

FIG. 9, which shows a schematic plan view of a conventional disk brake, illustrates that such a conventional disk brake does not have any free area corresponding to the free areas S1 and S2. Therefore the rim-side brake lining in a conventional disk brake cannot correspondingly escape the forces generated by the caliper expansion. These forces are indicated by arrows 44 and 46 in FIGS. 1 and 2. They arise while braking in the given rotational direction D of the brake disks 22 (corresponding to forward travel).

The free area S2 serves the same purpose as free area S1, but for backward and not forward travel.

In the portrayed exemplary embodiment, it is particularly advantageous when the free area S1 is larger than the free area S2. In other words, the asymmetry produces substantial mechanical advantages. The specific embodiment is the result of comprehensive field tests and calculations and depends on the brake size, lining quality and backplate thickness among other things. The contour of the free areas in the portrayed exemplary embodiment is optimum for a backplate thickness of 9 mm. This applies especially for angle α.

Alternately, the free area S2 can also be discarded or reduced to a mechanically irrelevant amount.

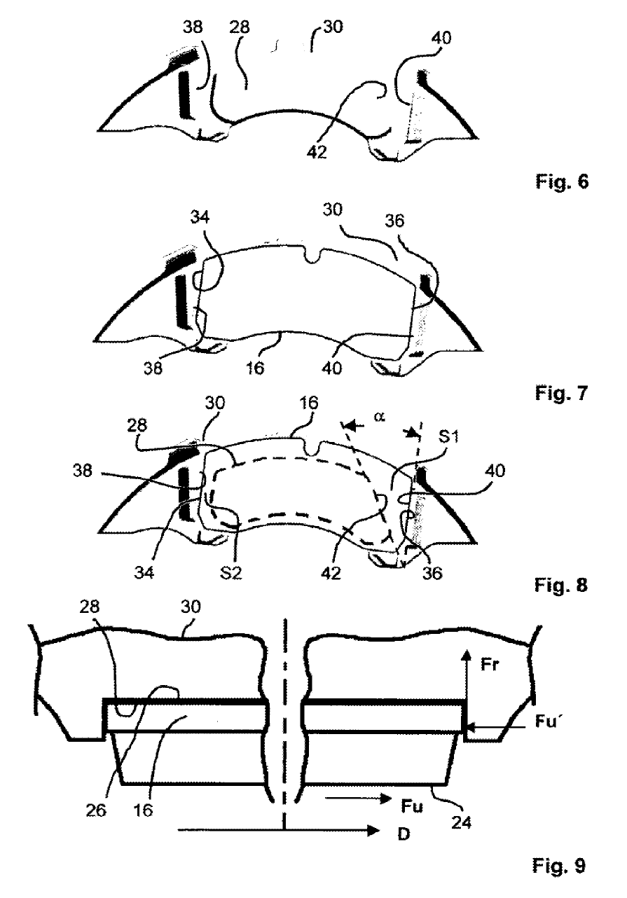

As can be seen in particular in FIGS. 6 and 10, the rim-side caliper limb is recessed with reference to contact surface 28 to form free areas S1 and S2 in the portrayed exemplary embodiment. In addition or alternately, the contact surface 26 of the rim-side brake lining 16 is recessed to form such a free area. Such an embodiment is schematically illustrated in FIG. 11. In FIG. 11, the hatched area 45 indicates an area where the backplate is thinner.

In addition or alternatively, the top or bottom edge of the free area S1 in FIG. 10 can be angled with reference to the other edge to produce a wedge-shaped free area in the depiction in FIG. 10.

The two caliper limbs 30 and 32 are connected by a caliper bridge 12.1, 12.2. The rotational axis of the brake disk is identified by the letter A.

The features of the invention disclosed in the above description, the claims and drawing can be essential to realize the invention in its different embodiments both individually or in any combination.

1-15. (canceled)

16. A disk brake comprising:
a brake disk with a rotational axis (A) and a preferred running direction (D);
an application device;
a brake caliper with a first caliper limb that is arranged on a first side of the brake disk and with a second caliper limb that is arranged on a second side of the brake disk situated opposite the first side of the brake disk, said second caliper limb being offset relative to the first caliper limb by a predetermined distance in the direction of the brake disk run-out side;
a first in brake lining which, during braking, bears by means of a first rear surface against a first contact surface on the application device, and by means of a first friction surface against the brake disk; and
a second brake lining which, during braking, bears by means of a second rear surface against a second contact surface on the second caliper limb, and by means of a second friction surface against the brake disk, the second brake lining being supported on the second caliper limb in the peripheral direction of the brake disk by means of a third contact surface; and
wherein the second rear surface, as viewed in the direction of the rotational axis (A), projects beyond the second contact surface in a radially outer region on the disk run-out side.

17. The disk brake of claim 16, wherein the second back surface projects beyond the second contact surface as viewed in the direction of the rotational axis (A) in a radially outer region (S2) at the brake disk run-in side.

18. The disk brake of claim 16, wherein a projecting area (S1) on the brake disk run-out side is larger than the projecting area (S2) on the brake disk run-in side.

19. The disk brake of claim 16, wherein the second caliper limb is recessed with reference to the second contact surface in the area in which the second back surface projects beyond the second contact surface.

20. The disk brake of claim 16, wherein the second brake lining in the area (S1, S2) in which the second back surface projects beyond the second contact surface is recessed with reference to the second back surface.

21. The disk brake of claim 16, wherein the second caliper limb to form the projection of the second back surface beyond the second contact surface is at an angle with reference to the second contact surface.

22. The disk brake of claim 16, wherein an edge of the area (S1) of the projection of the second back surface beyond the second contact surface encloses an angle of 5° to 60° with the third contact surface.

23. The disk brake of claim 22, wherein an edge of the area (S1) of the projection of the second back surface beyond the second contact surface encloses an angle of 15° to 45° with the third contact surface.

24. The disk brake of claim 23, wherein an edge of the area (S1) of the projection of the second back surface beyond the second contact surface encloses an angle of 35° to 35° with the third contact surface.

25. The disk brake of claim 16, wherein the second contact surface is rotated with reference to the first contact surface on the rotational axis (A) of the brake disk.

26. The disk brake of claim 16, wherein the second contact surface is pivoted on the rotational axis (A) of the brake disk with reference to the first contact surface.

27. The disk of claim 16, further comprising a connecting device to connect the first caliper limb to the second caliper limb that is radially closer to the brake disk on the brake disk run-out side than on the brake disk run-in side, at least in an area in which said connecting device encompasses the brake disk.

28. The disk brake of claim 16, wherein the disk brake is one of a sliding caliper brake or a fixed caliper brake.

29. The disk brake of claim 16, wherein the disk brake is a two-spindle brake.

30. The disk brake of claim 16, wherein the disk brake is a commercial vehicle brake.
